(19) United States
(12) Patent Application Publication
(10) Pub. No.: US 2017/0099592 A1
(43) Pub. Date: Apr. 6, 2017

(54) PERSONALIZED NOTIFICATIONS FOR MOBILE APPLICATIONS USERS

(71) Applicant: InterDigital Technology Corporation, Wilmington, DE (US)

(72) Inventors: Shoshana LOEB, Philadelphia, PA (US); Mohamed K. HASSANIN, Framingham, MA (US); Kuo-Chu LEE, Princeton Junction, NJ (US)

(73) Assignee: InterDigital Technology Corporation, Wilmington, DE (US)

(21) Appl. No.: 15/314,846

(22) PCT Filed: May 29, 2015
(86) PCT No.: PCT/US2015/033336

§ 371 Date: Nov. 29, 2016

Related U.S. Application Data
(60) Provisional application No. 62/005,507, filed on May 30, 2014.

(51) Int. Cl. H04W 4/18; H04W 4/20

(52) U.S. Cl. CPC H04W 4/18; H04W 4/206

(57) ABSTRACT

Personalized interrupt mechanism for users of computing devices where users may specify when and how they choose to be interrupted by mobile applications, games, in-app and in-game events, email, text, and other notifications based on application context and user preference. In some implementations, criteria for interruptions may be refined using machine learning techniques.

### CROSS REFERENCE TO RELATED APPLICATIONS

This application is the U.S. National Stage, under 35 U.S.C. §371, of International Application No. PCT/US2015/033336 filed May 29, 2015, which claims the benefit of U.S. Provisional Application No. 62/005,507 filed May 30, 2014, the contents of which is hereby incorporated by reference herein.

### FIELD OF INVENTION

This application is in the field of wireless communications.

### BACKGROUND

In today's highly connected world users may have multiple types of on-line application accounts such as emails (e.g., Gmail, Outlook), social networks (e.g., Facebook, Twitter), backend business productivity applications (e.g., CRM, SAP), as well as other professional subscriptions (e.g., news sources and news blogs). These users may track real time events and may wish to receive updates about events of interests in real time. Users may use their smart phone, tablet, or other mobile device as a primary method of checking these different applications. It is expected that the number of people and the frequency of use of such applications will be continue to grow and will create many update notification events that may disrupt users from doing useful work.

At the same time, users may be engaged in long duration personal activities or business tasks. Some users may be engaged in personal activities such as driving, playing video games, watching videos, listening to music, reading eBooks, or writing. Other users may be concentrating on business related tasks such as analyzing Web application statistics, tracking player in-game behavior and retention rate, or processing customer service tickets. During these long duration personal activities or business tasks, users may or may not wish to be interrupted by external events depending upon what the interruption is about and how important it is.

Many mobile applications and games collect user behaviors inside the application. This in-app or in-game behavior data may be sent to external systems for further analysis. Depending upon the analysis results, in-app or in-game advertising and reward notification events may be generated and dispatched back to the application as in-app or in-game notification events. To minimize disruption to the user engaging in important tasks or critical sections of a game for example, it may be desirable to allow the user to specify whether to accept and/or to allow the activation of the advertising, rewards or other in-app, or in-game notifications based on, for example, user preferences and/or the operation state of the application.

### SUMMARY

Personalized interrupt mechanism for users of computing devices where users may specify when and how they choose to be interrupted by mobile applications, games, in-app and in-game events, email, text, and other notifications based on application context and user preference. In some implementations, criteria for interruptions may be refined using machine learning techniques.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an example communications system in which one or more disclosed embodiments may be implemented;

FIG. 2 illustrates an overview of an example service architecture;

FIG. 3 illustrates an example evaluation process;

FIG. 4 illustrates an example context detection module;

FIG. 5 illustrates an example decision module process;

FIG. 6 illustrates an example event ranking and summary module;

FIG. 7 illustrates an example events selection and specification interface;

FIG. 8 illustrates an example of a complex event specification;

FIG. 9 illustrates an example of disabled mobile application notifications;

FIG. 10 illustrates an example carrier-level push mechanism;

FIG. 11 illustrates an example simple message service (SMS) message format for notifications; and

FIG. 12 illustrates an example architecture for distributed notification delivery using SMS proxying.

### DETAILED DESCRIPTION

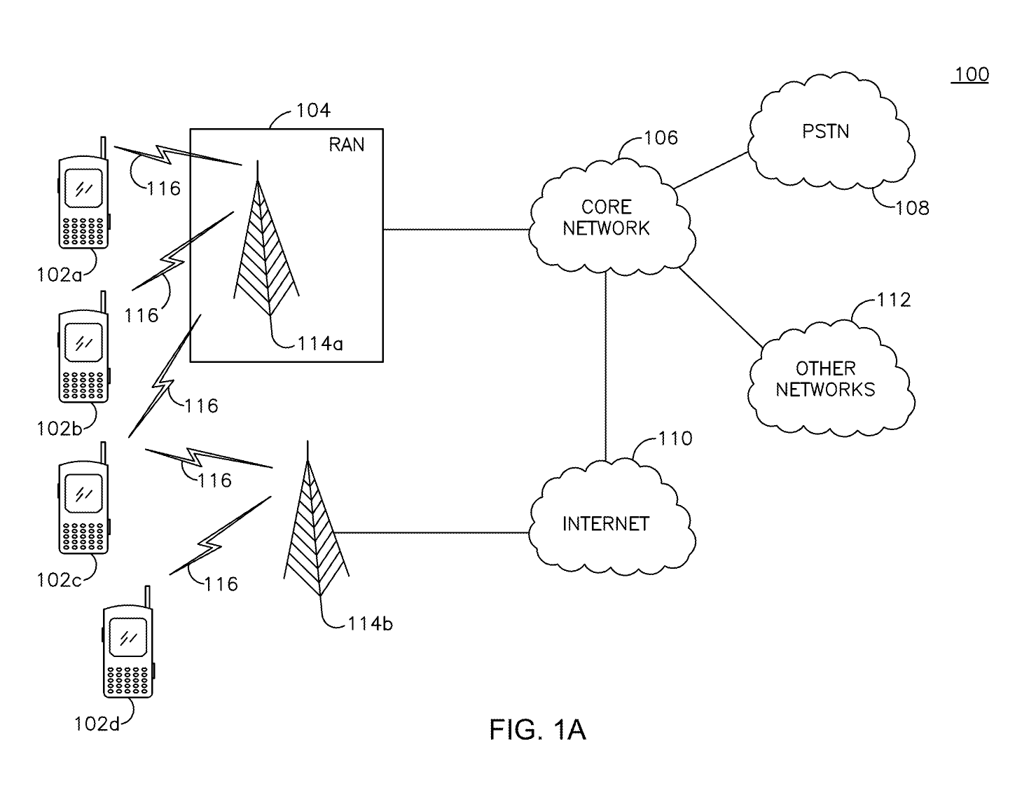

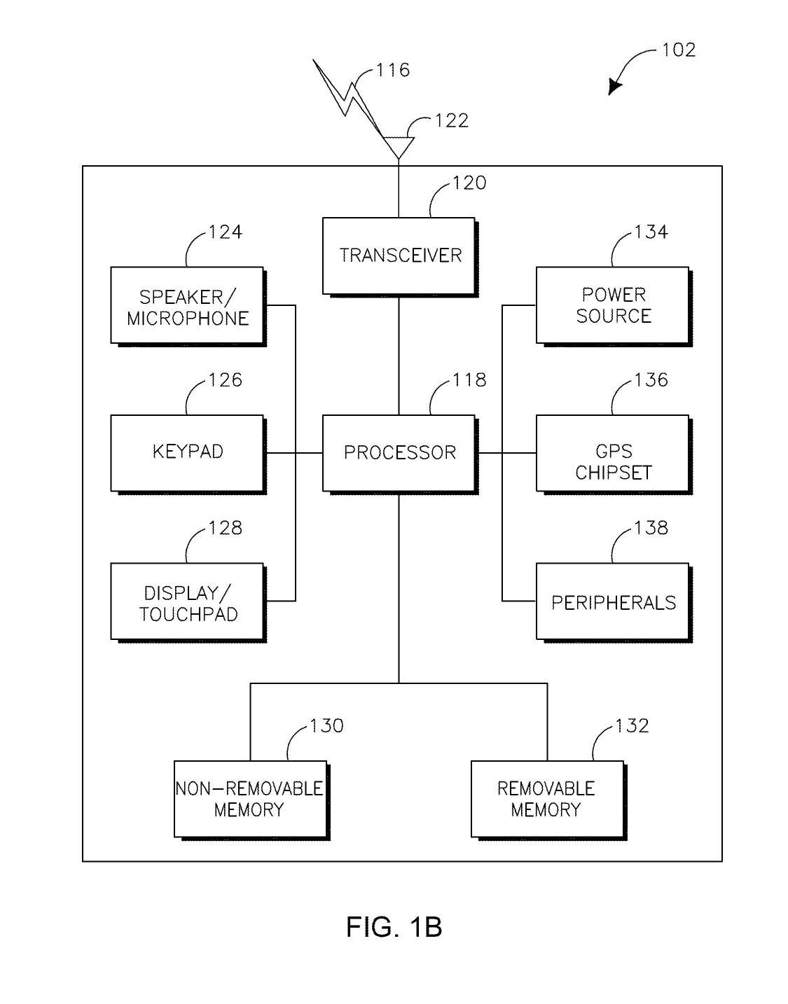

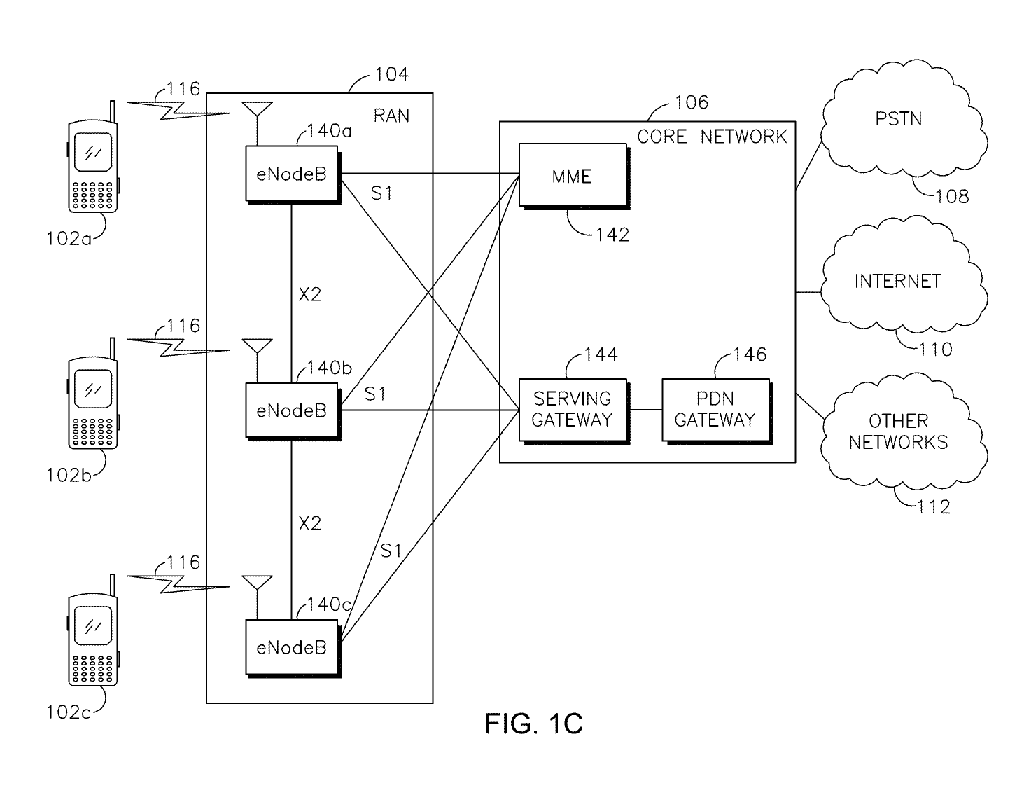

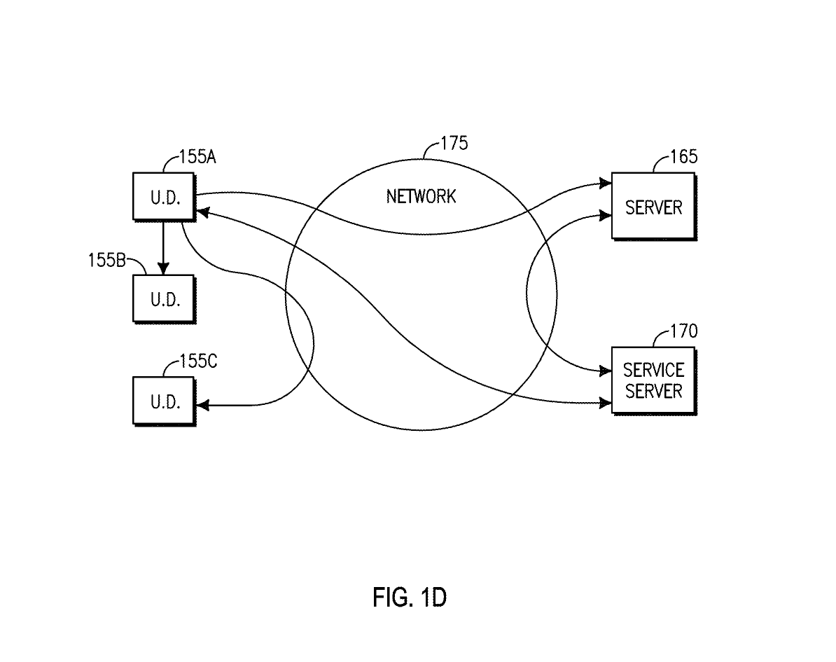

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a tablet computer, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1D is a system diagram of an example communications system 150 in which one or more disclosed embodiments may be implemented. In some embodiments, communications system 150 may be implemented using all or a portion of system 100 as shown and described with respect to FIG. 1A.

User device 155a, server 160, and/or service server 170 may communicate over communications network 175. These communications may be wireless, wired, or any combination of wireless and wired. Communications network 175 may include the internet 110, core network 106, other networks 112, or any other suitable communications network or combination of communications networks.

User device 155a may include a WTRU (such as WTRU 102a), or any suitable user computing and/or communications device such as a desktop computer, web appliance, interactive television (ITV) device, gaming console (such as Microsoft XBOX™ or Sony Playstation™) or the like. User device 155a and/or applications executing on user device 155a may generate events such as mouse clicks, keyboard strokes, and the like. These events may be processed by user device 155a and/or may be transmitted to another device such as server 160 or service server 170.

Server 160 may include a web server, application server, data server, or any combination of these or other types of servers. Server 160 may include any suitable server device such as a server computer, personal computer, or the like. Server 160 may host applications accessible to user device 155a. For example, server 160 may include a gaming server hosting a massively multiplayer online game (MMOG), an email server, a web server hosting a website such as a social media website or blog, or other types of servers typically accessible by a user device over a computer communications network.

User device 155a may access server 160 over computer communications network to interact with services that it provides. For example, user device 155a may access an email server hosted on server 160 to retrieve or send email. In some cases, the server may receive events from the user device, or may send events to the user device. For example, the server 160 may send an event to user device 155a indicating that new email has been received by an email server hosted on server 160.

Service server 170 may include a web server, application server, data server, or any combination of these or other types of servers hosted on a server device. Server 170 may include any suitable server device such as a server computer, personal computer, or the like. Service server 170 may be configured to receive and/or intercept events transmitted between user device 155a and server 160. For example, in some embodiments server 160 and service server 170 may be configured such that server 160 may send an event destined for user device 155a to service server 170 instead, and service server 170 may send the event or another event, signal, or message to device 155a. For instance, in a case where server 160 includes an email server, server 160 may send an event to service server 170 indicating that new email has been received, and server 170 may send the event or another signal or message to device 155a indicating that new mail was received by server 160. In some embodiments, server 170 may only forward the event to device 155a under certain conditions, such as based on a user preference and/or context information relating to the user of device 155a as will be discussed further herein.

In some embodiments, the functions of service server 170 and server 160 may be implemented using the same device, or across a number of additional devices.

In some embodiments, user devices 155b and 155c may communicate with server 160 and/or service server 170 via user device 155a. For example, user device 155a may forward a notification message from service server 170 to user device 155b via a peer to peer connection 180 and may forward a notification message from service server 170 to user device 155c via network 175.

Various approaches may be taken to address different aspects of mobile device notification event processing using filtering criteria of different complexity. For example, different kinds of filtering rules may be applied which may be based on information such as user preference, urgency, importance level associated with the originator, destination, network, and user availability status, device connectivity status, and other special media contents. A generic agent based system may include, for example, a mechanism to dynamically update and load service logic rules, such as sending rules for an event originator (i.e., source), network routing rules, such as for finding a suitable destination, and termination filtering rules, such as for special treatment of the incoming events of different types.

Push notification services may be provided to allow users to manage notification events. Users may configure notification filters provided for each application (e.g., email, social media, unified communication, and push notifications from mobile apps) using one or more application specific settings. In current systems, however, disabling notifications may burden the user by requiring them to remember when to turn notifications back on and the user may be required to keep track of which application notification events were turned off. These configuration processes may be complicated and may require the user to switch between applications. Users may also turn notifications on and off using mobile device settings. In current systems, however, once the notification of a specific application in the device is turned off, all events from the application may be blocked regardless of the importance of these events.

According to some embodiments and as further described herein, users may specify when and how to be interrupted by various types of mobile applications (such as games) and/or in-app or in-game events, based on application context and/or user preference. As further described herein, methods and devices may be applied to various aspects of mobile applications and mobile game services, including mobile application and game service management and customer support, personalized service, and bring-your-own-device (BYOD) management.

In the context of mobile application and game service management and customer support, dynamic personalized and context aware rules may be implemented for managing notification events. This may be done, for example, to minimize disruption of external or in-game events and/or to maximize user retention. Personalized services may be implemented to improve user satisfaction with mobile application and game push notification services. In the context of BYOD, multiple message event notifications may be implemented monitor and balance consumption of business and personal related events.

Described herein are, among other things, approaches to addressing these various aspects of mobile applications and mobile game services described above, including enabling users of different aspects to interact. This may be done, for example, using cross-application filtering rules which may be predicated on multi-dimensional attributes representing the application context and events collected from multiple mobile applications and games. The following use cases exemplify ways in which multiple application contexts and user preferences may be specified by users from multiple application domains to achieve personalized interruptions.

Mobile application users: A) if I am driving my car in NJ, i) do not interrupt me, except when my wife sends me an urgent email or text message, then show a popup notification at the bottom of the screen.

Game players: A) if I am playing a video game on my PC or mobile device, i) do not interrupt me a) unless my parent sends me a text message, or b) unless I am not in real-time interaction. B) If I am busy on my homework (e.g., on-line homework assignment, inferred from calendar or set by user), i) do not interrupt me a) with any email, b) unless it is urgent email from school or c) friends from Facebook™ ii) insert all the game match invitations in my “to play” list.

Game service agents: A) If I am working on an in-game behavior event ticket from a VIP player of a new game in a promotion list, i) do not interrupt me for any other player in the same game ii) do not interrupt me for VIP Player from other games that have a lower preference level. B) If I am working on monitoring all pending analytic events from multiple web applications or games, i) interrupt me if there is any abnormal behavior from the VIPs ii) Interrupt me if there are too many players quitting the game.

Bring Your Own Device (BYOD): A) if I am just off-duty (inferred from the calendar or set by user), i) lower the business application importance level ii) show me all the notifications in a dashboard based on a) my preference on originator, b) the web application name and c) an urgency level of the Web application.

Battery power preservation: A) if my cell phone is not in an internet protocol (IP) mode or has less than 10% battery, i) do not enable social media application notifications ii) only allow notifications for urgent events and send them using the simple message service protocol (SMS).

Cost saving event dispatching: A) if a device is not connected using an IP network, i) send a notification message to a device with an IP connection and request the device to send the notification event to the destination device using SMS.

Described in further detail herein, among other things, are a service architecture and function modules in the context of a server and mobile device event evaluation process flow; automated user preference learning and task application context detection; a cross-application event ranking and summary display dashboard; a service registration, events selection and specification interface; and scalable interrupt distribution methods for minimizing server notification delivery cost and/or conserving battery power.

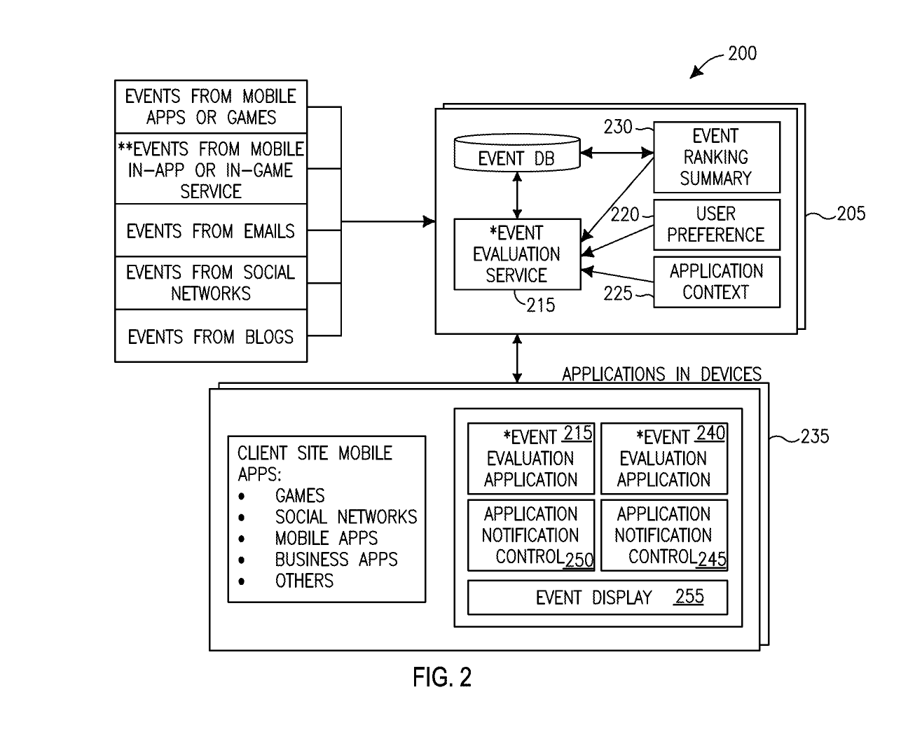

FIG. 2 illustrates an overview of an example service architecture 200 for providing personalized user notifications. Service architecture 200 may be implemented using any suitable combination of hardware and/or software. It is noted that in FIG. 2 and elsewhere in this application various functionality may be described as implemented in a particular module, however, it is noted that these modules are exemplary and that in different embodiments the functionality described with respect to a plurality of modules may be implemented using a single module or vice versa.

The overall service architecture 200 shown in FIG. 2, may include server service modules 205 and/or mobile device application modules 230. The server service modules 205 may include or be included in, for example, program applications executing on a server (such as server 170 as shown and described with respect to FIG. 1D). The mobile device application modules 230 may include or be included in, for example, program applications executing on a user device (such as user device 155a as shown and described with respect to FIG. 1D). It is noted that the bifurcation of the various functions of the modules described herein between a mobile device and a server is exemplary, and various functions may be implemented and/or performed on either the user device, the server, or both the user device and the server under certain circumstances or all circumstances depending upon the desired implementation.

Server service modules 205 may include, for example, one or more of an event database 210, event evaluation module 215, user preference module 220, user state module 225, and event ranking and summary module 230. Event database 210 may include a database which stores events and/or the state of the events (e.g., pending dispatched, acknowledged, etc.). Event evaluation module 215 may execute user specified rules to decide when, where and/or how to send the events to the user, and may also use one or more user preferences to determine an importance level of an event. User preference module 220 may record one or more user preferences, such as user preferences for different event types and different Web applications and games for example. User state module 225 may record user state, such as an application context that the user is working on, where the user is located, and/or other state information related to the user. Event ranking and summary module 230 may receive events from one or more mobile applications, social networks, business processes, and games as inputs, rank the importance level of events based on user preference and display a summary of ranked events.

Mobile device application modules 235 may include, for example, one or more of an event evaluator 215, an application context detector module 240, a preference rule configuration user interface module 245, an application notification control module 250, and an event display module 255. It is noted that as with other modules, event evaluation module 215 may be implemented on the server side as a server service module and/or on the mobile device side as a device application module.

Event evaluator 215 may detect various events 290 and calculate whether to issue a notification and/or what notification or type of notification to issue, and to what device the notification should be issued. Events 290 may include events from mobile applications or games, such as notifications of new Facebook™ posts or invitations to join a game; events from in-app or in-game services, such as on-line service support chat or advertisements; events from emails, such as important email from spouse or bank statement notifications; events from social networks, such as LinkedIn™, or Facebook™ friend invitations, events from blogs such as professional forums or blogs related to games; and/or other types of events. It is noted that the evaluation of events may be performed by a mobile device application module such as event evaluator or proxy 235, a server side application such as will be discussed further herein, or both, depending upon the desired implementation.

Application context detector 240 may detect application context, such as, for example, which application the user is using. Application context detector 240 may update the application context service 225 in the server based on the application context. Preference rule configuration user interface 245 may include, for example, a user interface configured to allow a user to define various rules such as an importance level of an event, an interrupt level of a context, and so forth. Application notification control module 250 may include functionality for controlling interactions between the user and mobile applications in the device. For example, application notification control module 250 may permit a user to disable notifications from mobile application services such as App Store™ and Financial News™. Users may set up rules to disable these mobile application services when they are driving or when the user's cellular data plan are about to exceed a limit, for example. Module 250 may also deliver incoming events to activate one or more advertisements, rewards, or other tasks inside a mobile application or game. Event display module 255 may include, for example, functionality for displaying pop-up messages or other types of alerts to notify the user of an event.

In some embodiments, the service described with respect to service architecture 200 may be activated by a user in several ways, which may include subscribing to a personalized notification interrupt service; selecting a set of mobile applications and games to join or otherwise interact with the service; downloading and installing a service agent mobile application, which may contain an event evaluator, context detection module, or a proxy agent that interacts with these functions as implemented on a server; and/or enabling application context detection and location services on a mobile device.

Described further herein is an example event evaluation process flow. The service 200 described with respect to FIG. 2 may include two separate logical entities responsible for making decisions. The first logical entity may be referred to as an evaluator and the second logical entity may be referred to as a context detector. The evaluator may be implemented in a server and may be responsible for evaluating events and checking whether preconditions have been met independent of the user's context. The evaluator module may reside in the cloud with the service server (not shown). Portions of the evaluator module may reside on the user device (not shown). The context detector may receive notifications from the evaluator and may determine any action to be taken based on the notification and the user's policies and context. The evaluator may reside on one or more of the user's devices (e.g., as a client side application) and/or may reside on a cloud server (e.g., as a server side application).

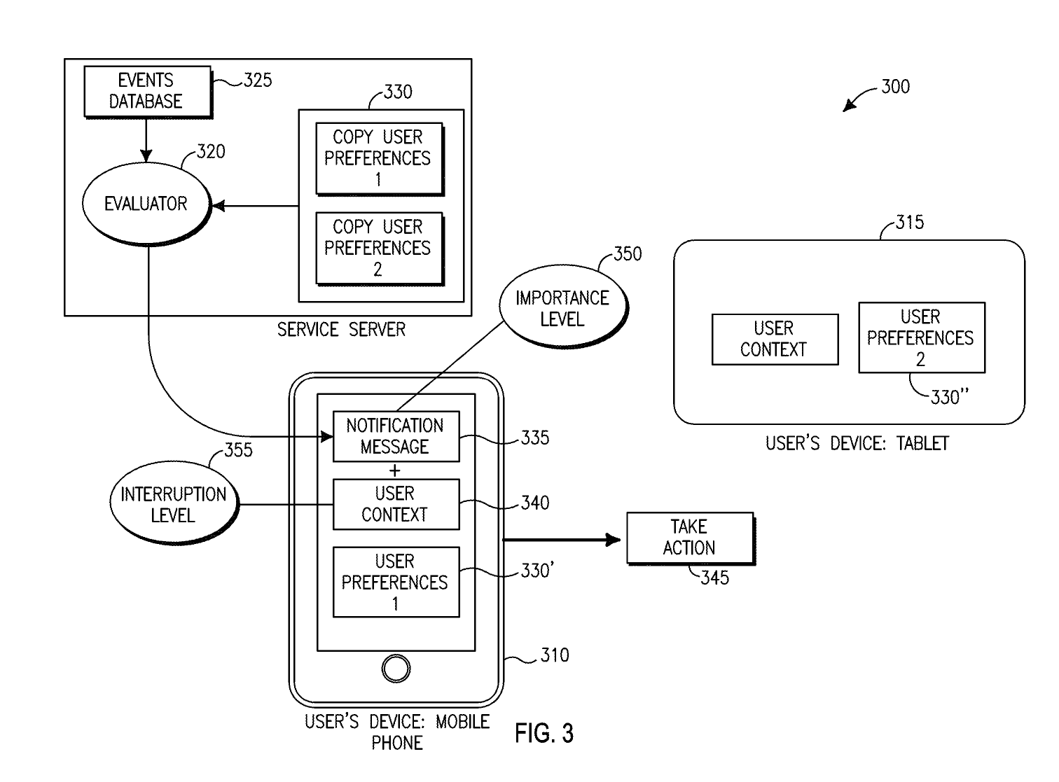

FIG. 3 is a system diagram illustrating an example event evaluation process 300. Event evaluation process 300 illustrates example interactions among a service server 305, and user devices 310 and 315. Service server 305 may implement some or all of the functionality of service server modules 205 (FIG. 2), and user devices 310 and 315 may implement some or all of the functionality of mobile device application modules 235 (FIG. 2). It is noted that this topology is exemplary, and that various other combinations of servers and user devices may be employed in different embodiments.

In event evaluation process 300, an evaluator 320 may be implemented in server 305 and may receive information from an event database 325 when a user-defined event has occurred (e.g., a new event has been detected by an event handler interface provided by notification or messaging services). The evaluator 320 may evaluate the event based on user preferences 330′, 330″ to determine to which, if any, of the user devices 310 and 315 a notification should be sent. These user preferences may be the same or different as desired for the different user devices 310 and 315. In this example, a local copy 330 of the user preferences is referenced by the evaluator 320, however, in various implementations this information may be stored in another location, such as another server or device (not shown).

In the scenario shown in process 300, evaluator 320 determines based on user defined events and user preferences that a notification message should be sent to user device 310 and should not be sent to user device 315. Accordingly, user device 310 receives a notification message 335 from the service server 305 based upon this determination. The user device 310 then evaluates the received notification message 335 and determines an action 345 (if any) to take based upon user context 340.

An evaluator, such as module 320 at the server, may potentially receive events from many sources. Accordingly, it may become challenging to perform real time evaluations. Various systems have been proposed to deal with such problems. Described herein are systems and methods which may be used to perform real time large scale evaluation of the complex events defined by the user.

A real time evaluation system may update the state of each user event state (e.g., the system has detected that a user has join a meeting or has received over 80% of their monthly data plan) only once a transaction has been processed by the evaluation system. The system may detect other user defined event condition patterns (e.g., detect if the user is the presenter in a Web conference or if the user is driving and have the cellular data on, etc.) in conjunction with the previously detected and updated states. This may eliminate the need to store and process all transactions in order to evaluate patterns of events.

Application context detection is discussed in further detail herein. A context detection module may track aspects of the user's activities. For example, such a context detection module may track which applications are currently running on each device, an amount of time (e.g., active interaction time) spent by the user on each application, the geo-location of each device, and/or other context information. This data may be applied to implement various functionalities discussed herein.

The user may also associate one or more importance levels 350 with one or more notification events or types of notification events. These importance levels may be implemented on the user side (e.g., in user device 310 and/or 315) to enable complex behaviors. Importance level 350 may specify, for example, whether or how many times a message should “pop-up” on a screen of the device to ensure that the user sees the message. In another example, importance level 350 may specify a location and/or size of the message on the screen (e.g., a small icon on the lower right hand side of the screen or possibly a more direct pop up).

The context detection module may construct an interruption level 355 for the user based on, for example, the current applications that a user is using, time of day, date, and/or user provided preferences. For instance, a user may opt not to receive notifications while sleeping at night except for urgent messages, and to receive other non-important notifications the next day. The user may also specify an interruption level 355 for various notifications. For example, the user may choose not to be interrupted for certain events while texting or writing an email (i.e., using a text or email application), or may choose to be notified for certain events even if he is currently in an active phone conversation.

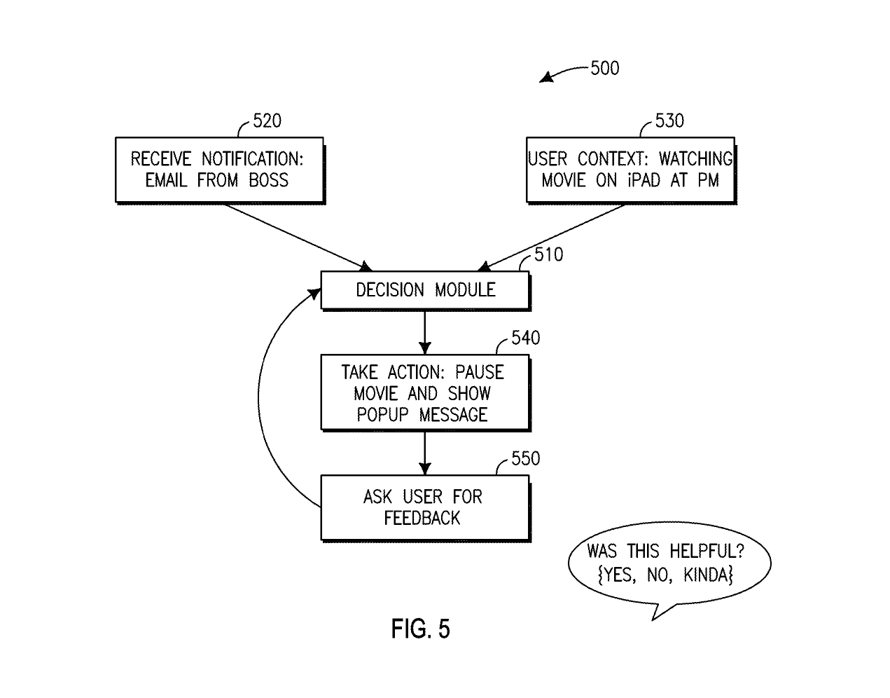

To facilitate user selection of importance level 350, a number of interruption modes such as “do not disturb” “silent”, “urgent only” or “anticipated event” may be selectable and applied for a period of time, for a specified location and/or for specified tasks in which the user may be engaged, or other contextual parameters. Accordingly, both the importance level 350 of a notification (e.g., that depends on a triggering event) and the interruption level 355 (e.g., derived from the user context), may determine an action that the application should take in response to notification message 335 (e.g., whether and how to present the notification). An example in which a decision module generates an action based on an importance level and an interruption level is shown in FIG. 5.

User context may be established based on one or more parameters, which may include, for example, the current application that user is using; how the user is interacting with the application (e.g., watching/typing/talking/playing);a battery level of a user device; user location (e.g., based on the location of a user device); user physical activity level (e.g., moving, running, e.g., as sensed by a user device via location services, accelerometers, heart-rate sensors, and the like); time of day; user calendar (e.g., is the user on the way to a meeting); a period of time specified by the user as “do not disturb”; and/or which device the user is currently using (e.g., for a particular application).

In some embodiments, the client-side application may react to the notification and the inferred user context in a variety of ways. Some possible actions that the client-side application may take (e.g., in response to a notification being received at the user's device) include, for example, doing nothing at the present time and showing a notification message when the device switches from “power-saver” to normal operation mode; vibrating the device (e.g., phone) and/or causing a notification light to blink; displaying a popup message to the user if the mobile device is active and/or interrupting the current activity; and/or displaying a notification message after a certain activity is over (e.g., displaying a message only after the user has finished a phone call). In some cases, if allowed by a privacy setting, the application may inform the source of the notification about the delivery status (i.e., whether the notification was received by or at least presented to the user).

As the number and complexity of mobile applications and in-app activities increases, detecting and defining user context parameters may become increasingly complex for end users. Accordingly, a context detection and summary module for monitoring user activities automatically may reduce the complexity for the user.

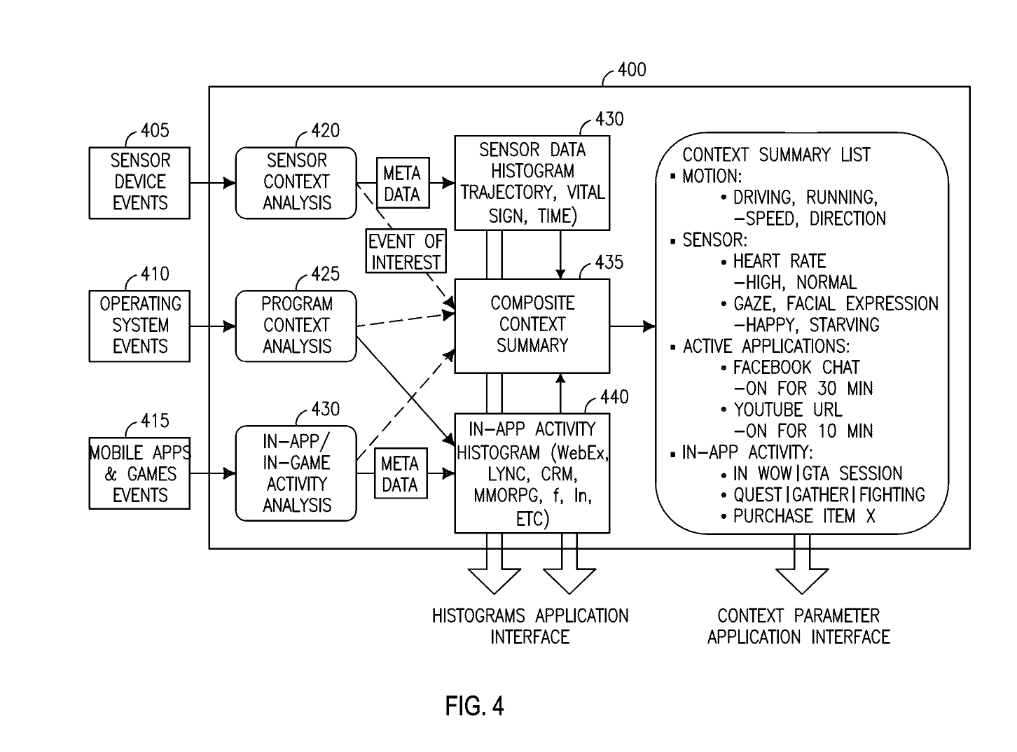

FIG. 4 shows an example real-time in-app context detection module 400. Context detection module 400 may include an application programming interface (API), program, program function, or a portion of a program, and may execute on a server. Context detection module 400 may be implemented in the service architecture 200 as shown and described with respect to FIG. 2 (e.g., application context detection module 225 and/or 240) and may be implemented using any suitable combination of hardware and/or software. Inputs to the example context detection module 400 include sensor device events 405, operating system events 410, and mobile app/game events 415.

Context detection module 400 includes several analysis modules configured to analyze input from the sensor devices 405, 410, 415. Sensor context analysis module 420 receives the sensor device events 405 as input and performs analysis on these events. Program context analysis module 425 receives the operating system events 410 as input and performs analysis on these events. In-app/game activity analysis module 430 receives mobile app/game events 415 and performs analysis on these events. Although the analysis modules 420, 425, 430 are described as separate units in this example, it is noted that any or all of these modules may be implemented using a single unit or several additional units.

The analysis modules 420, 425, 430 each generate output data based on the input events. In this example, each module generates metadata and identifies events of interest. These analysis results may be stored in any suitable data structure. For example, the analysis results may be stored as a histogram and/or organized in a data cube, to support context analysis. In this example, metadata from the sensor context analysis module 420 is stored in a sensor data histogram 430. Sensor data histogram 430 may track trajectory, vital signs, and/or time measurements, for example. Metadata from the program context analysis module 425 and in-app/game activity analysis module 430 are stored in an in-app activity histogram 440. Histogram 440 may store the probability distribution of different user activities such as a frequency or duration that users may be using Web conference services or playing different types of games. Events of interest identified by each of the analysis modules 420, 425, 430 are summarized in a composite context summary 435.

Example outputs of the context analysis module 400 may include a context summary list 445. The context summary list 445 may include data representing various context information regarding the user, user device, or user applications, which may be used as input parameters to a context awareness module.

For example, context summary list 445 may include a list of tag value attributes which list business tasks or personal activities. Some such tasks and activities include user motion (e.g., driving or running, and the speed and direction in which the user is driving or running); user sensor data (e.g., heart rate, and whether the rate is normal or high; user gaze or facial expression, and whether the expression is happy or staring); active applications (e.g., whether the user is engaged in Facebook™ chat and for how long, or whether the user is accessing a YouTube™ URL, and for how long); user in-app activity (e.g., whether the user is logged into a World of Warcraft™ or Grand Theft Auto™ gaming session, whether the user is engaged in a quest, gathering activity, or fighting activity within the gaming session, and whether the user has purchased or is purchasing a particular item within the gaming session).

The following is an example of a dynamic, personalized, interrupt level adjustment process for game players. In this example, a particular in-game event, “Click Per Minute”, CPM, is used as a behavior indicator to adjust the interrupt levels for different game types and tasks. A use case is also described for the importance level adjustment process for different notification sources based on player's response behavior to each notifications.

For a First Person Shooting (FPS) game, where a player is fighting a monster or defending a base, a player behavior indicator such as CPM may increase. Where the player has just successfully passed a level or is in the process of selecting avatars however, the CPM may decrease. The interrupt level may thus be dynamically adjusted based on CPM to prevent low importance notifications from interrupting the game. For example, an average CPM, CPM.avg and standard deviation, CPM.std of player X may be tracked and stored in a player profile. The interrupt level for the CPM, CPM.INT.level may be mapped to a category from 1 to 10 as show in the following example:
IF (CPM>CPM.avg+5 CPM.std), then CPM.INT_level=10
IF (CPM<CPM.avg −5 CPM.std), then CPM.INT_level=0.
Else,
//map CPM to [1 to 10],
CPM.INT_level=((CPM−CPM.avg)+5 CPM.std)/CPM.std)

The example above may be applied to many different types of parameters such as motion speed (e.g., motionSpeed.avg and motionSpeed.std), distance and area covered by avatar. Where a vital sign monitor is available, user heart rate (pulse.avg, pulse.std) may also be used to measure the intensity of in-game activities for adjusting the interrupt level. A high pulse rate may be mapped to a high interrupt level to block less important notifications for example.

For a puzzle game or a board game, CPM may not appropriately reflect the intensity of the game activity. Instead, “puzzle start” and “opponent move” action events from the game engine or opponents may be captured as an activity indicator. An action per minute indicator, APM, may therefore be used to determine the interrupt level. Typically, there are few or no actions per minute during a puzzle or board game. When there is an action (e.g., a prompt by the game engine or move by the opponents), the APM may immediately increase to a high value compared to the average. After that the APM will decrease. Using APM to adjust the interrupt level may prevent a player being interrupted when an action has just occurred. These notifications may be delivered to the player at a later time when APM eventually drops to a lower level.

The pattern of play sessions may also provide an indication of the player's preferences, and may be used to adjust the interrupt level. For example, if a player often plays a first person shooting game with friends on Friday night and is currently playing a game session, the interrupt level of the player may be adjusted to be higher on Friday night. The interrupt level may also be lowered automatically after the player stops playing the game. This play pattern based dynamic interrupt level adjustment may also help the player to avoid forgetting to reset a “do not interrupt” configuration manually after it is set for an important multi-player game sessions.

Similar to the interrupt level adjustment, the importance level of notifications may be dynamically adjusted based on user behavior. For example, if a user responds to a notification at a lower importance level faster than that the user responds to a notification at a higher importance level, it may imply that the user is beginning to treat the source of the lower importance level notification more seriously and that it should be assigned a higher importance level. For example, in a situation where a game player has historically ignored another player who is not in a friend list and later this other player becomes a teammate, notifications from the new teammate may be opened more quickly than notifications from other sources. As a result, the importance level of the notification from the new teammate may be raised and an importance level of notifications responded to more slowly from another source may be decreased to a lower level.

The following pseudo code illustrates an example mechanism for learning and adjusting an importance level for a game player. If a notification is delivered to a user, it may be tagged with a sending time. If the notification is opened by the user, it may be tagged with an opening time. The difference in time between the sending time and the opening time may be referred to as a response time delay, NRT. The following example illustrates learning and adjustment of the importance level of each notification source.
/*Collect the NRT.avg and NRT.std for each source context and map the importance level, NRD.IMP.level to a level between [0-10].
Similar to CPM to interrupt level mapping. */
//Adjust the NRT.IMP.level.
//detect SourceX with faster response time but lower importance level than SourceY.
IF NRT.avg(SourceX)<NRT.avg(SourceY) and SourceX.IMP.level<SourceY.IMP. level,
Then,
//Increase the SourceX importance level and decrease SourceY importance level.
SourceX.IMP.level=
SourceX.IMP.level+((NRT.avg(SourceY)−NRT.avg(SourceX))/ (NRT.avg(SourceX)+NRT.avg(SourceY)))
SourceY.IMP.level=
SourceY.IMP.level+((NRT.avg(SourceX)−NRT.avg(SourceY))/ (NRT.avg(SourceX)+NRT.avg(SourceY)))

The above example illustrates one mechanism for automatic adjustment of importance level based on response delay by acquiring and analyzing the NRT. Similar mechanisms may be employed to adjust an importance level of a source that is originally below an interrupt level. For example, detecting that a user is responding quickly and consistently to a source of notifications having a lower importance level than the interrupt level, may be considered to be a strong indication that the importance level of the particular source should be raised above the interrupt level, and the importance level may be raised accordingly.

Example context parameters that may be captured by the detection module include motion trajectory history, position, direction and speed information, and user status such as heart rate and gaze or facial expressions detected by external visual analytic systems. Motion trajectory, user status, and in-app activity events may be important context information for external service management, customer retention, and monetization applications.

Results of the context analysis may be stored in a fast access memory with an application programming interface (API) to allow access from other function modules such as the context awareness module described previously or a machine learning module. In particular, non-supervised learning of abnormal behaviors based on event histogram may be supported.

For in-app and in-game services that utilize the personalized interrupt service, the states of the in-app (or in-game) tasks may be analyzed by the context detection module 400 and tracked by the application context module in real-time. Upon receiving in-app events, the event evaluator may access the context of the application as well as in-app tasks to decide whether to interrupt the user and/or enable in-app and in-game tasks. The in-app and in-game events may be evaluated together with other events as well as the current context of the application targeted by the in-app events and based on user preference and overall application contexts. Accordingly, the in-app or in-game advertisements, rewards or other types of actions may not be activated if their associated importance levels are lower than an interrupt threshold (e.g., wait) or if they are disabled by a user specified rules (e.g., no in-app or in game pop-ups). Note that even though an in-app event may have been originally triggered by the user behavior within the application, the interrupt level of in-app and in-game context may have changed. Processing of the in-app events, therefore, may be deferred or cancelled based on the new in-app or in-game context and user preference in real-time.

A machine learning module is described further herein. A context detection module (such as context detection module 240, 400) may be configured by the user regarding when to be interrupted and can set various configurations on when to be interrupted. In some embodiments, the context detection module may be configured with predefined “settings” and these settings may adapt to the user using supervised learning in which the context detection module would take an action and the user would provide feedback on the action as illustrated in FIG. 5.

FIG. 5 is a flow chart illustrating an example process 500 incorporating a decision module 510. In process 500, the decision module 510 inputs an event 520 and a user context 530. Event 520 and user context 530 may be input to the decision module 510 from user context detection module 400 (FIG. 4).

In this example, event 520 is a notification that an email has been received from the user's boss, and context 530 is an indication that the user is watching a movie on a tablet computer and that the time is 9:00 PM. Based upon current rules for decision, decision module 510 may determine to take action 540 based on event 520 and user context 530. In this case, action 540 is to pause the movie and to show a popup message to the user on the tablet. After action 540 (or possibly along with action 540) decision module 510 (or another related module) solicits user feedback 550. For example, a selection menu may be presented to the user after the popup message is displayed on the tablet, or the selection menu may be presented along with the popup message. Decision module 510 inputs the user feedback and may use this information to update or adjust the current rules for decision. For example, if the user feedback 550 indicates that the popup message was not helpful, the decision module may refrain from displaying a popup message in this context.

While process 500 employs supervised learning techniques to adapt decision module 510, unsupervised learning techniques may also be implemented in which the user context detection module 400 may consider an action (e.g., displaying a message, displaying a notification item, causing a beep, and so forth) and observe the behavior of the user in response to the action (e.g., whether the user read the message, whether the user closed/resumed the application that he was working on, etc.). Thus, in the example of FIG. 5, rather than soliciting user feedback 550 to adjust decision rules in decision module 510, the context detection module 400 may detect user interactions following or in response to action 550 and may adjust the decision rules based on the detected interactions. The context awareness module may also be implemented using a hybrid approach in which the user may set configurations of the application and a machine learning algorithm may also be used to modify this set of configurations.

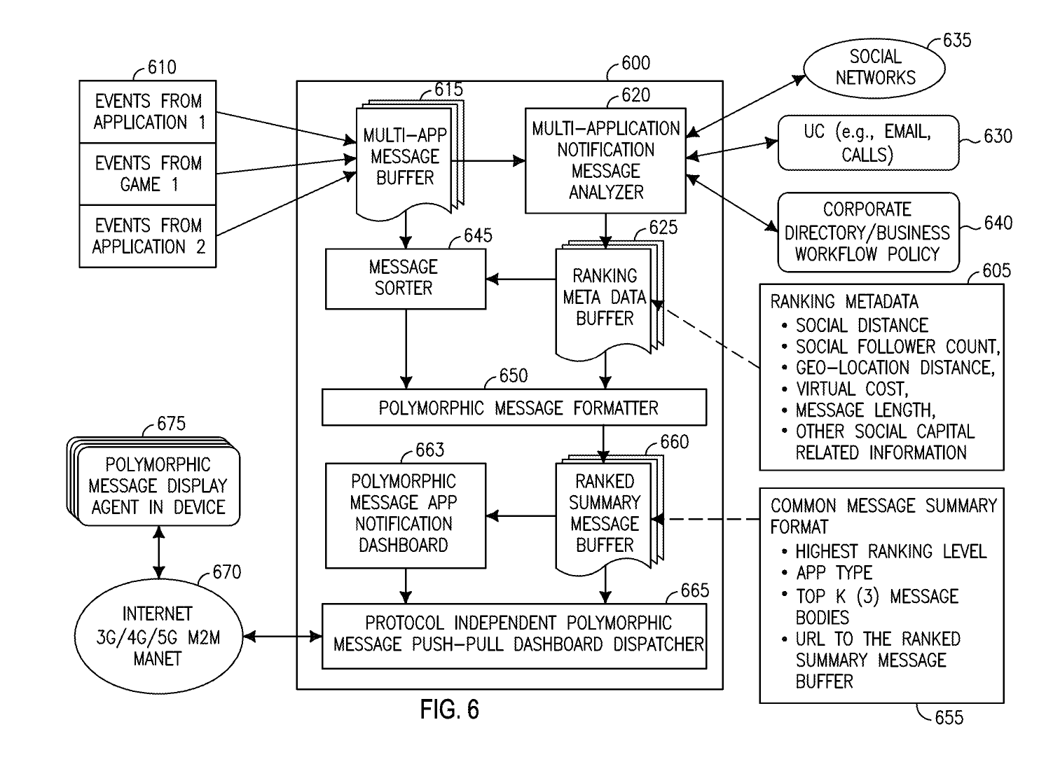

FIG. 6 illustrates an example event ranking and summary module 600. Event ranking and summary module 600 may be used in the context of service architecture 200 (e.g., as event ranking summary module 230, FIG. 2) and may extract metadata from various types of applications or application events (e.g., Unified Communications (UC), social network, mobile applications and games) and convert the metadata to multi-dimensional attributes in a structured format that may be used as an input event to an event evaluator. Event ranking and summary module 600 may also rank multiple types of events based on the user preference so that a ranked summary table can be used to generate a dashboard for the user to select the most important pending events.

Event ranking and summary module 600 includes message buffering, analysis, sorting, formatting, summary information dashboard, and push/pull dashboard dispatching to automate the multiple application message filtering, rank notifications and streamline the notification processing functions. This functionality may exceed the capabilities of current mobile push notification solutions.

Metadata 605 may include application parameters such as originator application; recipient application, social distance, social follower count, geospatial distance, application name, message importance, and anticipation level. Originator application metadata (i.e. metadata relating to an application sending a message or generating an event) may include a name and type of the application, including identifiers for in-app or in-game tasks. Recipient application metadata (i.e. metadata relating to an application receiving a message or event) may include a name and type of the application, including identifiers for in-app or in-game tasks. Social Distance metadata may include a social network distance between the originator and recipient. The social distance may be obtained from one or more social networks using a social network API. Social network crawler tools or APIs may be used to build a detailed distance metric. A user may also manually override the distance. Social follower count metadata may include a number of followers in a specific social network associated with the application.

Geospatial distance metadata may include, for example, a geolocation separation distance between originator sending a message and destination device receiving the message. Application name metadata may include an in-app or in-game task identifier for the application that invoked the notification, e.g., email, Facebook, Twitter, App_1_In-App_Task_2, etc . . . }. Message importance metadata may include an importance indicator as set by the application that sent the notification (e.g., priority in an email message). Anticipation level metadata may include a level indicating a degree to which a message is expected by the user. For example, a reply to an urgent email may be assigned a high anticipation number even though the sender may not mark the reply message as urgent. In another example, a reply may be assigned a high anticipation number where a user is awaiting the reply from customer support regarding a high severity complaint.

For the various metadata 605 discussed above, each parameter may be normalized to a quantifiable range between (−1 to+1). The normalized parameter may then be formatted with a simple tag value format including type definition and time stamps. The formatted parameters may form multidimensional attributes for an event evaluator.

A set of weights may also be assigned to the each of the attributes based on user preference, manually and/or automatically by a machine learning module. A weighted summary may express a rank of an event which may be used to sort events received from multiple sources. The normalized and typed attributes may support ranking, sorting, event evaluation, and summary dashboard display of multiple types of events.

As shown in FIG. 6, the example event ranking and summary module 600 may receive events 610 from one or more mobile applications, social networks, business processes, and games as inputs, and may generate a set of ranked formatted metadata attributes and ranked summary dashboard messages. Example sub-modules of event ranking and summary module 600 may include multi-app message buffer 615, message analyzer 620, message sorter 645, polymorphic message formatter 650, and protocol independent push-pull formatter dispatcher 665.

Multi-app message buffer 615 may store messages from multiple applications and push notifications from multiple mobile platforms. Message analyzer 620 may perform deep message analysis and extract a set of common and application specific metadata. The resulting metadata may be stored in a ranking metadata buffer 625. The analyzer may search unified communications sources 630 (e.g., email, phone calls), social networks 635, or corporate directories 640 other business workflow repositories to obtain more personalized or more contextually relevant metadata for decision making (e.g., to determine whether the originator is the recipient's boss, whether the message is from abroad, or whether the message is a reply from a previous sent email marked as urgent). The analyzer may also generate metadata by invoking one or more social network APIs or search one or more social networks to obtain a distance matrix for the user from one or multiple social networks. Message sorter 645 may scan the metadata stored in ranking metadata buffer 625 and may sort messages stored in message buffer 615 based on the ranking of the metadata. Message formatter 650 may map messages to a common message summary format 655, such as by rank, application type, originator, destination, timestamp, JavaScript Object Notation (JSON) message payload, metadata, URLtoPullMsg, and so forth. The formatted message template may be queued in a message buffer 660 and subsequently displayed on a message application notification dashboard 663.

Protocol independent push-pull dispatcher 665 may push a summary message, which may include for example a list of tuples. Each tuple may include, for example, Highest-Ranked Event, application type, and total number of events of the same type. The summary message may be sent by SMS, mobile ad hoc network messaging, or other well-known protocols through mobile, wireless, and/or wired networks 670, such as via the internet, 3G/4G/5G, machine-to-machine (M2M), and/or mobile ad-hoc network (MANET) communications.

The user message display filter 675, (message display agent), may receive the ranked summary messages at the user device and determine an action to be taken based on the received summary messages, user context, and user preferences. In some embodiments, users may specify preferences and context parameters manually or automatically (via Machine Learning techniques). The preference and context parameters may be used in conjunction with decision rules to process the incoming messages.

In some embodiments the user may register one or more applications to participate in the personalized user notifications system. This may be done in several ways. For example, if a user registers with a service server (e.g., a server implementing server service modules 205 as shown and described with respect to FIG. 2), the user may be provided with an email address to which the user can forward his or her mail or news feed directly. Other implementations may include requiring the user to register his or her email address with a service server, where the service server is responsible for receiving or retrieving all the emails and messages from an original email server (similar to Microsoft Outlook™). Applications such as Facebook™ Twitter™ and LinkedIn™ may also provide APIs for 3rd Party developers to receive the user's news feed, messages, post, friends list, and so forth. The user may also subscribe to RSS feeds, and simply provide the RSS feed link to the service server which would be responsible for receiving the feed for the user.

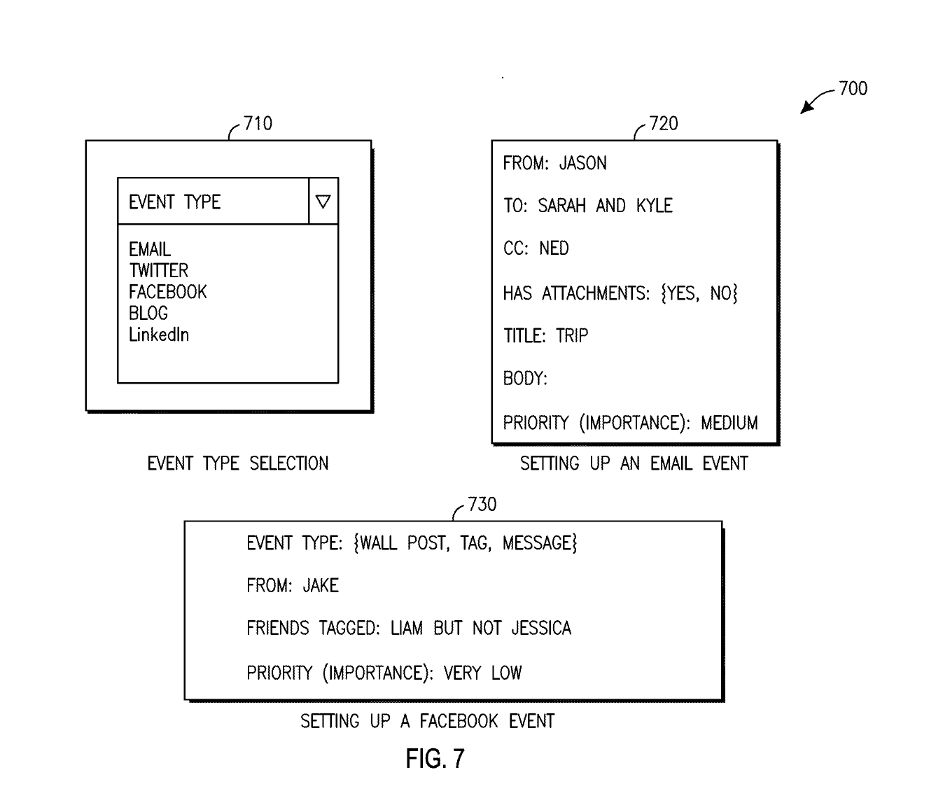

FIG. 7 illustrates an example events selection and specification interface 700. Interface 700 may permit a user to create and specify event handling parameters. The features of interface 700 may be specific to the kind of application for which the user wishes to specify an event. The user may select a type of event and based the selected type, the user may fill in the appropriate event criterion as shown in FIG. 7.

For example, the user may select an event type (e.g., Facebook™ email, and so forth) from drop-down menu 710 and may then be prompted to specify parameters for that particular event. For instance, in the example of FIG. 7 a user may select a notification event type using drop-down menu 710. The user may then be prompted with parameter fields for this type of event, and the user may then fill the fields to specify the desired event. In one example, the user may specify an email event type using drop-down menu 710. The user may then be prompted with parameter fields 720 which are relevant to email type events. Here, the user may specify a sender, key words in the title and/or body, a priority of the message, whether the message contains an attachment, and so forth as shown in parameter fields 720.

By filling the fields shown in 720, the user may create parameters for an event which trigger a notification message to be sent to a user device when an email meeting the specified parameters is received in a designated email account, depending upon other interactions within the system (e.g., service architecture 200). In another example, the user may specify a Facebook™ event type using drop-down menu 710. The user may then be prompted with parameter fields 730 which are relevant to Facebook™ type events. Here, the user may specify an event type (e.g., wall post, tag, message), a recipient, friends tagged, and a priority level, for example. Other possible parameters may include specific reasons for the notification (whether it is a message from a friend, a message from outside the user's network, a message from the friends involved in the post, whether the post has a picture and so forth). Many other parameters are possible for other types of events, such as Twitter™, LinkedIn™, or blog-type events.

An event evaluation service at the service server (such as event calculation module 215 as shown and described with respect to FIG. 2) may analyze notification streams received from an underlying application (e.g., Facebook™ or email) based on the specified events. If the user-specified conditions match an incoming notification from the underlying application for example, a user defined event may become active and may be passed to an event ranking summary module (such as event ranking summary module 230 as shown and described with respect to FIG. 2.

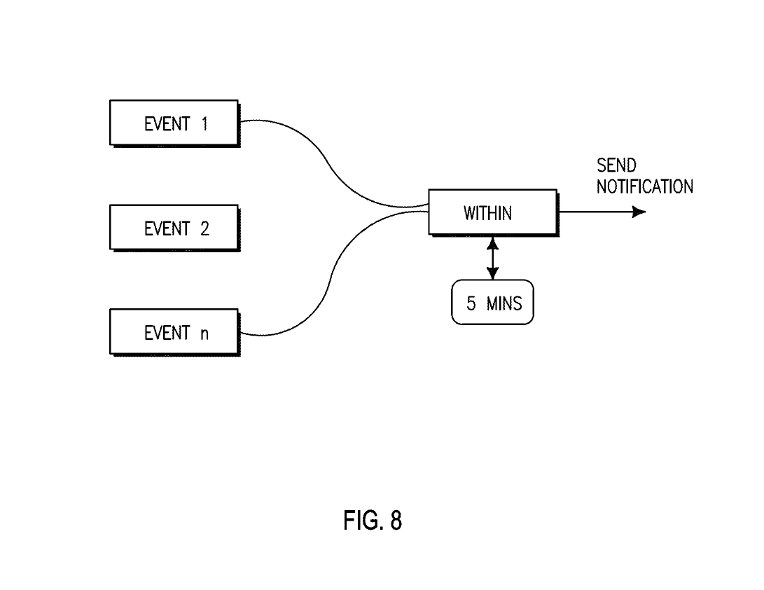

More complex and/or compound events may also be specified. For example, a user may be provided with the ability to specify conditions related to the occurrence of multiple events. In one example, a user may specify whether an interruption or notification should be sent immediately after a set of preconditions is met or whether to delay the notification until a later time when an additional condition or set of conditions is met. For instance, the user may specify that the service server combine multiple events in a meaningful way before the service server sends the notification. For example a user could specify “send me a notification only if event 1 and event 2 occur within 5 minutes of each other.” This case is illustrated in FIG. 8. In another example, the user may create notification requests for repeated events. For example, the user may wish to be notified if the user is tagged in Twitter™ more than 5 times. It is noted that other combinations of events are also possible.

In some embodiments, notifications may be issued for underlying applications such as Facebook™, email, and others, where these applications have their own dedicated notification systems. For example, Facebook™ may have a dedicated notification server to service Facebook™ applications running on mobile devices. In order to avoid sending duplicate or cumulative notifications to the user from both the notification service server and the underlying application's own notification server (such as the Facebook™ server), the underlying applications' native notification method may be turned off. This process of modifying the underlying application notification process may be accomplished in several ways.

In one example, the underlying application notification process may be turned off at the user device using the underlying application's API. For example, the API for the Facebook™ mobile application provided by Facebook™ developers to turn off the notifications may be used. In another example, the notification service server may modify the notification processes of the underlying applications. This may be accomplished using APIs invoked at the notification service server which interface with the underlying application server (such as a Facebook™ server or Gmail™ server). In another example, an interface may be established with the notification system of a specific platform to modify or disable it altogether for the underlying applications (e.g., interfacing with an Apple™ notifications server, Kindle™ notifications server, or the like.) In another example, a user may be requested to manually shut down notifications from each application that he/she registers with the event notification service server.

The client side application (or the service server) may determine (possibly based on the user preferences and context) whether to pass certain notifications to the underlying application or whether it should take more complex action.

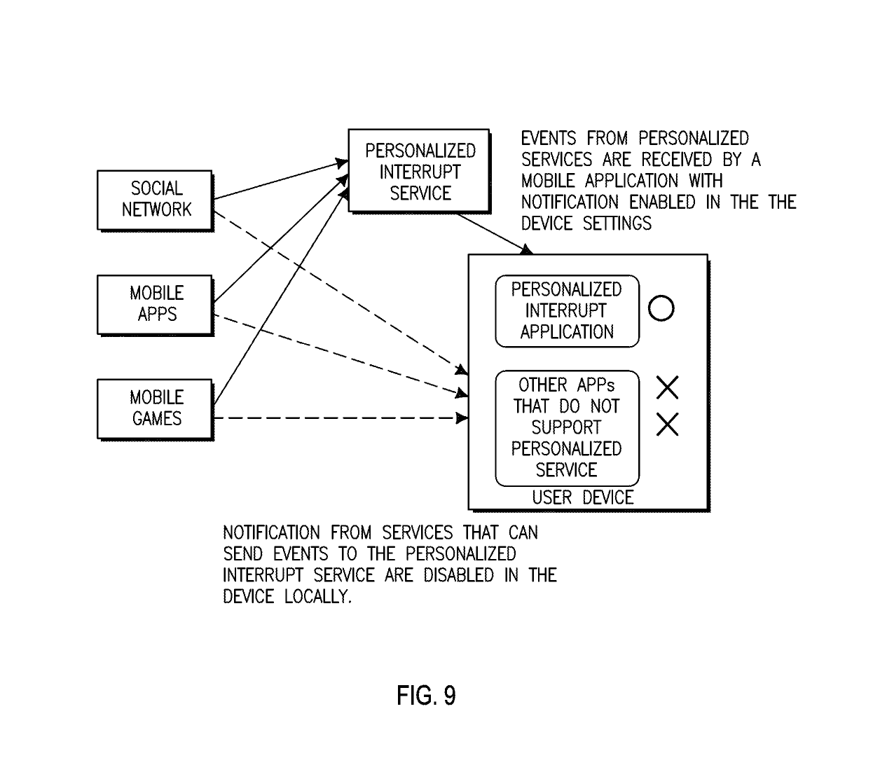

FIG. 9 is a system diagram which illustrates disabling of original notifications sent by underlying applications (e.g., Facebook™, Twitter™, etc.) as described above. The disabling of the original notifications may be performed via APIs that control the underlying application or service (e.g., a Facebook™ API) or its proxies (e.g., Apple™ Notification Server, Android™ Push Service, and the like) or it may be performed via the API of an application residing at the user device (e.g., Facebook™ mobile application). In the example of FIG. 9, notifications from mobile applications are disabled by default.

In some embodiments, personalized notifications may be implemented across multiple different user devices by managing coordination among these various devices. User defined policies for each device may be stored on each respective device and/or can be stored at the service server.

It is noted that a user may be offered the option to only transmit user preferences (e.g., that the user wishes for a pop up to be shown on my phone when an email from boss arrives) to the service server and not to send the current user context. By not sending the complete context, user privacy may be preserved, and computational and bandwidth load on the server may be reduced. A copy of the user preferences may be provided to the respective devices in order to implement cross device functionality (e.g., a preference to send a notification to a laptop device for a Facebook™ message only if a mobile phone device is not reachable). In some embodiments the service server may store the preferences of all client side applications running on the different user devices if the user trusts the service server to receive his/her context. In some embodiments, desired behaviors other than cross device functionality may be implemented without having a copy of the user's preferences stored at the server, and a notification sent by the evaluator may be processed at the respective device's context awareness module to determine which action to take.

In some embodiments, each user device may store a copy of the registered events and other metadata that is stored in the service server. Each device may keep its copy synchronized and up to date with the service server's copy. For example, if the user accesses the service server using a mobile phone, the metadata may be updated through that web session. However, if the user has modified the events and actions from another device (e.g., a desktop or another phone that is not associated with the user account), then the user may be notified that these changes will not take place until the devices affected by the modification are synced. The server may also store a copy of the user preferences for all devices (e.g., user preferences pertaining to each of a user's multiple devices).

Notifications may also be provided to devices in a power saving mode. A notification may be sent to user devices, for example, either via the Internet (TCP or UDP connection) for laptops and tablets or via the Internet or standard SMS messages in case of mobile devices. Although application servers which service mobile devices may have the ability to push content to the user device, such push interaction may function only where the user device is in a connected mode. This may require that the user device be always connected to the internet and maintain a connection with the server that contains the content (usually a TCP connection). This may be accomplished by having the server send packets to the user simply to keep the connection open. Such behavior may negatively affect mobile device batteries due to the RF circuit frequently receiving and sending empty “keep-alive” packets.

Accordingly, mobile devices may operate in a “power-saver” or stamina mode when they are in standby mode. In such power saving modes, internet functions may be disabled and the mobile device may only be able to receive SMS, multimedia message service (MMS) and operator phone calls. However in this circumstance the mobile device may no longer immediately receive push notifications from the server and may be required to wait until the mobile device transitions from the “power save” mode to the normal mode of operation before receiving push notifications.

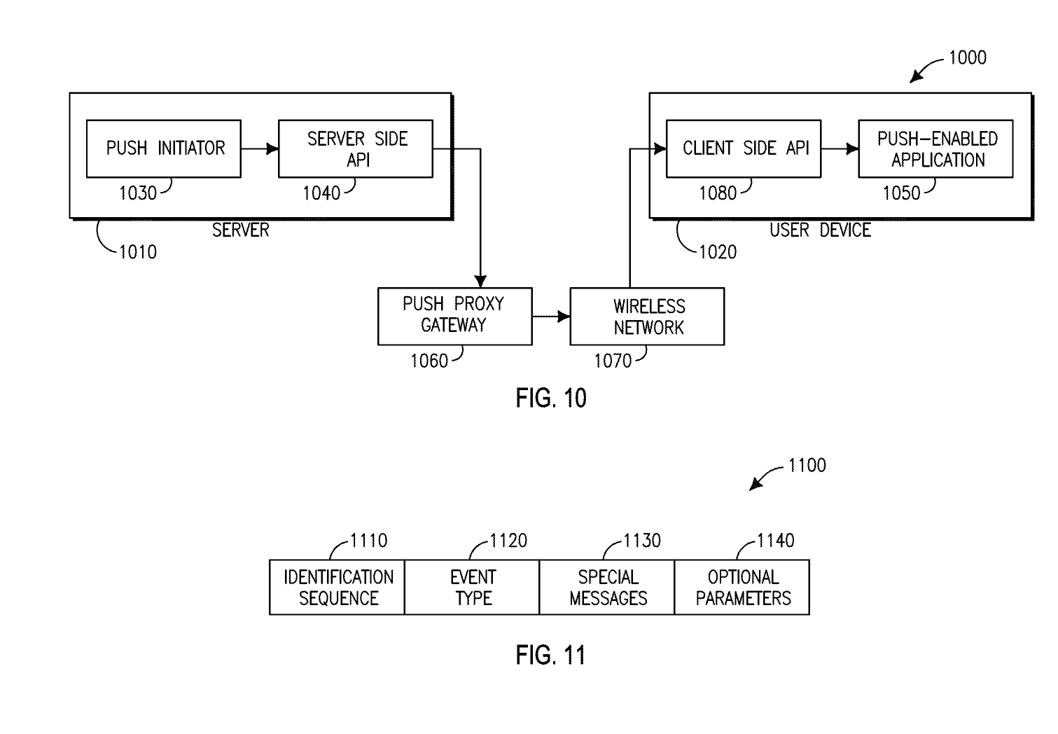

FIG. 10 illustrates an overview of an example carrier-level push mechanism 1000. Carrier level push mechanism 1000 includes a server 1010 configured to push a message (or other information) to user device 1020. Server 1010 includes a push initiator module 1030 configured to initiate transmission of a message (or other information) to the subscribing user device 1020. Push initiator 1030 may interface with a server side API 1040 to communicate with a push enabled application 1050 running on user device 1020 via a client side API 1060. The server 1010 may push the message to the user device 1020 by sending a push notification via the server side API 1040 to push proxy gateway 1060 which pushes the message to user device 1020 via one or more communications networks, such as wireless network 1070.

A carrier itself may provide push services that do not require a connection to the internet at all times (e.g., Blackberry's™ push services and as shown in FIG. 10). However, carrier-level push functionality may be in the control of the application owner itself. Moreover, web applications may not provide any carrier level push mechanisms. Further, some modern web application developers may not be familiar with carrier level push APIs.

In some embodiments, users may be provided with instant notifications when they are in the “power-saver” mode even if the application does not provide a carrier level push mechanism. In some embodiments, the service server (e.g., service server 305 as shown and described with respect to FIG. 3) may send an SMS message with the notification to the user (e.g., user device 310 as shown and described with respect to FIG. 3). In some embodiments the server may try first to reach the mobile device via the Internet, and may try to reach the mobile device via SMS if unable to reach the mobile device via the Internet.

SMS messages are currently limited in size to 140 characters. Accordingly, it may be necessary to use these characters efficiently to convey the notification type and a description and details of the event. This may be facilitated by storing a copy of events registered with the server at the user devices such as is explained in further detail herein. Thus a copy of registered user defined events and associated metadata may be stored in the client side mobile device and the SMS message may simply contain an index indicating which event was fired, an index of the message to display, and/or other parameters. Such an SMS message may have a format as shown in FIG. 11 for example.

FIG. 11 is a block diagram showing an example of one such SMS message format 1100. In example SMS message format 1100, the SMS message includes an identification sequence 1110 that may serve as identification to the applications that the SMS message stems from the service server and may serve as an authentication to verify that the SMS originated from the service server. Any suitable cryptographic authentication protocol can be used to establish the identity of the server and verify that the message is intended for a specific user. It is noted that the authentication process may not be an interactive process, i.e., the mobile device may be required to be able to verify the identification sequence 1110 without establishing a connection to the server. This condition may be required, for example, in cases where it is undesirable to establish a connection to the server each time an SMS message is received by the mobile device. Such connection activity may require transmission via the Internet, for example, which may cause the user device to enter an “active mode” and undermine user control over when and how to use the resources of the user device.

In some embodiments, message format 1100 may include an event type field 1120, special messages field 1130, and/or optional parameters field 1140. Event type field 1120 may include application code defining the source application and message type. Special message field 1130 may include application specific index codes for retrieving predefined messages saved in either the server or the device to save communication bandwidth and/or an importance level of the message. Optional parameters field 1140 may include application or user specific message contents.

Another possible approach to synchronizing a local user-device copy of registered events and other metadata with the corresponding information stored at the service server where the user device (e.g., mobile device) is in a standby mode may include sending a notification SMS message to the user device, for example via an implementation or partial implementation of service architecture 200 (FIG. 2), instructing the user device to wake from the power-save mode and to execute a synchronization application to synchronize the local user device copy with the service server copy of the registered events and other metadata.

Distributed notification delivery is discussed further herein. If a service server (such as service server 305 as shown and described with respect to FIG. 3) has a substantial user base, in some implementations mobile devices of some of the users who have an active Internet connection may proxy an SMS notification message to other users. If the service server has a large user base, then at any given time, a non-trivial percentage of the users may be actively communicating using their device (e.g., surfing the web, talking, texting). It has been noted that in some situations, mobile device users may be connected to a Wi-Fi network approximately ⅓ of the time. Moreover data plans offered by wireless service providers may include free texting (SMS).

In some implementations, a service server may ping or otherwise query user devices over TCP to determine whether the user devices are not in a standby or power saver mode. If one of the devices is active, the server may send a notification message over the Internet to that mobile device. Thereafter, the mobile device to which the notification message was sent may forward the notification message via SMS to an intended mobile device. To avoid over-exploitation of a single device, in some implementations the number of SMS messages sent by mobile devices in such circumstances may be limited to one or two per day, or another suitable threshold, for example.

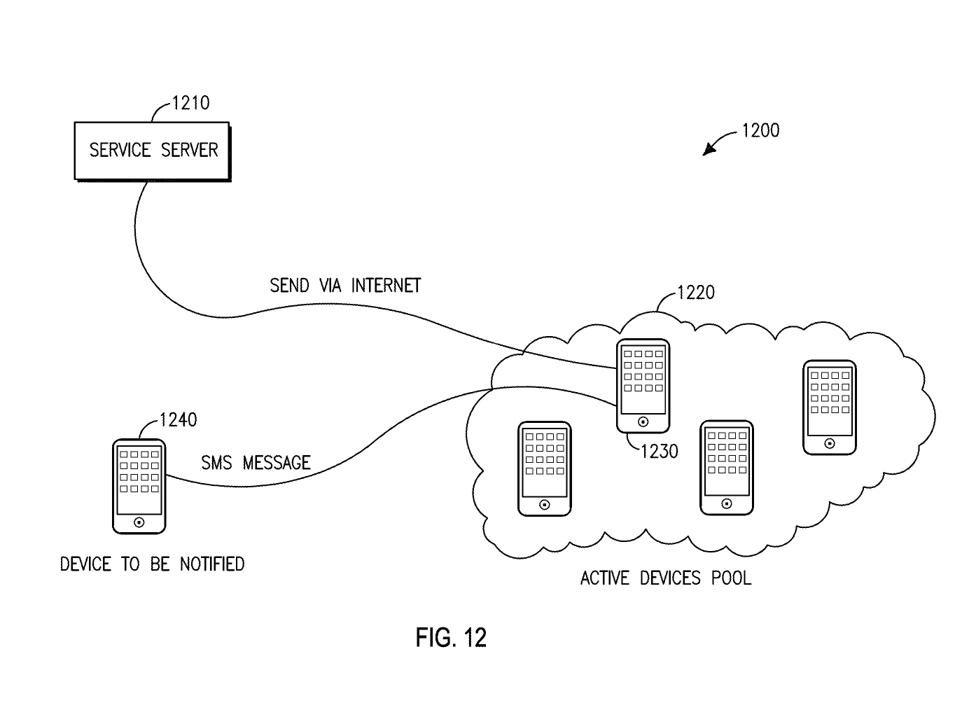

FIG. 12 illustrates an example architecture 1200 for distributed notification delivery using SMS proxying. Service server 1210 pings a pool 1220 of registered devices via TCP to determine whether they are in an active mode. In this example, user device 1230 returns an indication that it is in an active mode (i.e. not in a standby or power saving mode). Service server 1210 then transmits a notification message via the internet (or another suitable communications network) to device 1230 for forwarding to user device 1240. In this example, user device 1240 is in a standby mode and/or does not have a connection to the internet. Device 1230 then forwards or retransmits the notification message to device 1240 via an SMS message.

Proxying the SMS message to a secondary mobile device in this way may have the advantage of potentially reducing costs at the service server by reducing the number of SMS messages sent by the server. Such proxying may also provide system scaling flexibility, and may accordingly reduce operational costs of the service through economies of scale.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for providing a personalized notification to a user of a communications device, the method comprising:
receiving an indication that an event has occurred;
determining whether a user should receive a notification based on the indication,
an application context, and
a user context, wherein the user context includes a social distance between the user and an originator of the event or a social follower count of the originator;
on a condition that it is determined that the user should receive the notification,
providing the notification to the user,
wherein the notification is provided to the user in a format based upon at least one of the indication, the application context, or the user context.

2. The method of claim 1, wherein the application context comprises at least one of an identity of an application, a run state of the application, a running duration of the application, a user interaction duration with the application; a type of the application, or a user action with the application.

3. The method of claim 1, wherein the user context further comprises at least one of a user name, a user location, a user speed, a user schedule, a current time, a current date, a current activity, a power status of a user device, a user preference, a user activity level, a user vital sign, a user eye movement, or an interruption level.

4. The method of claim 3, wherein the user preference comprises at least one of an importance level of the event, a notification format associated with the event, an interruption mode, a priority level of a message sender, a priority level of a message format, or a priority level of a message source application.

5. The method of claim 3, further comprising determining the user preference dynamically based on machine learning.

6. The method of claim 3, further comprising determining the user preference dynamically based on user feedback.

7. A server device configured to transmit a notification to a user device, the server device comprising:
a receiving module configured to receive an indication that an event has occurred;
a determination module configured to determine whether a user of a user device should receive a notification based on:
the indication,
an application context, and
a user context, wherein the user context includes a social distance between the user and an originator of the event or a social follower count of the originator; and
a notification module configured to provide the notification to the user on a condition that it is determined that the user should receive the notification,
wherein the notification is provided to the user in a format based upon at least one of the indication, the application context, or the user context.

8. The device of claim 7, wherein the application context comprises at least one of an identity of an application, a run state of the application, a running duration of the application, a user interaction duration with the application; a type of the application, or a user action with the application.

9. The device of claim 7, wherein the user context comprises at least one of a user name, a user location, a user speed, a user schedule, a current time, a current date, a current activity, a power status of a user device, a user preference, a user activity level, a user vital sign, a user eye movement, or an interruption level.

10. The device of claim 9, wherein the user preference comprises at least one of an importance level of the event, a notification format associated with the event, an interruption mode, a priority level of a message sender, a priority level of a message format, or a priority level of a message source application.

11. The device of claim 9, further comprising a user preference determination module configured to determine the user preference dynamically based on machine learning.

12. The device of claim 9, further comprising a user preference determination module configured to determine the user preference dynamically based on user feedback.

13. A system for transmitting a notification to a user, the system comprising:
a server in communication with a user device over a communications network;
wherein the server includes:
a receiving module configured to receive an indication that an event has occurred, and
a first determination module configured to determine whether a message should be sent to the user device based on the indication,
a user preference, and
an application context, and
wherein the user device includes:
a second determination module configured to determine whether a notification should be presented to the user based on the message and a user context, and
a notification module configured to provide the notification to the user on a condition that the second determination module determines that the notification should be presented to the user,
wherein the notification is presented to the user in a format based upon at least one of the message, the application context, the user context, or the user preference.

14. The system of claim 13, wherein the application context comprises at least one of an identity of an application, a run state of the application, a running duration of the application, a user interaction duration with the application; a type of the application, or a user action with the application.

15. The system of claim 13, wherein the user context comprises at least one of a user name, a user location, a user speed, a user schedule, a current time, a current date, a current activity, a power status of a user device, a user preference, a user activity level, a user vital sign, a user eye movement, or an interruption level.

16. The system of claim 13, wherein the user preference comprises at least one of an importance level of the event, a notification format associated with the event, an interruption mode, a priority level of a message sender, a priority level of a message format, or a priority level of a message source application.

17. The system of claim 13, wherein the user device further comprises a user preference determination module configured to determine the user preference dynamically based on machine learning.

18. The system of claim 13, wherein the user device further comprises a user preference determination module configured to determine the user preference dynamically based on user feedback.

19. The system of claim 13, wherein the server is configured to receive the indication on behalf of the user device.

20. The system of claim 13, further comprising a second user device, wherein the second user device forwards the message to the user device using a simple messaging service (SMS) protocol on a condition that the user device is in a power saving mode.
